(19) United States
(12) Patent Application Publication
(10) Pub. No.: US 2016/0007545 A1
(43) Pub. Date: Jan. 14, 2016

(54) PLANT CULTIVATION SYSTEM

(71) Applicant: CHUNGHWA PICTURE TUBES, LTD., Taoyuan County (TW)

(72) Inventors: Yu-Wen YEN, Chiayi County (TW); Chun-Chieh CHIU, Taoyuan County (TW); Chien-Hung CHEN, New Taipei City (TW); Yue-Li CHAO, Taoyuan County (TW)

(21) Appl. No.: 14/512,464

(22) Filed: Oct. 13, 2014

(30) Foreign Application Priority Data
Jul. 14, 2014 (TW) 103212468

(51) Int. Cl. A01G 9/02; A01G 7/02; H04B 1/38; A01G 27/00

(52) U.S. Cl. CPC A01G 9/02; A01G 27/005; A01G 7/02; H04B 1/38

(57) ABSTRACT

A plant cultivation system including a main body, a cultivating dish, an environmental condition detecting unit, a control center module, and an actuation unit. The main body has an accommodating space. The cultivating dish is located in the accommodating space for cultivating a plant. The environmental condition detecting unit is located in the accommodating space for detecting an environment parameter in the accommodating space and correspondingly generating an environment parameter signal. The control center module includes a wireless transceiver module and a system chipset module. The wireless transceiver module is electrically connected to a monitoring device.

### RELATED APPLICATIONS

This application claims priority to Taiwanese Application Serial Number 103212468, filed Jul. 14, 2014, which is herein incorporated by reference.

### BACKGROUND

1. Technical Field

The present disclosure relates to a plant cultivation system. More particularly, the present disclosure relates to a home plant cultivation system that is wirelessly controlled.

2. Description of Related Art

A conventional home plant cultivation system cannot be remotely controlled. Therefore, when a horticulturist leaves the home, the plants cannot be real time and appropriately cared. Furthermore, the conventional plant cultivation system can only control temperature, humidity, and brightness with simple functionality. However, different plants need different growing conditions. Even the same kind of plant needs different growing conditions during germination and maturity. Therefore, the requirements of a horticulturist cannot be satisfied by the same growing conditions.

Accordingly, it is important to design a home plant cultivation system that allows a horticulturist to remotely take care of plants and modify the growing conditions of the plants according to actual needs.

### SUMMARY

The disclosure provides a plant cultivation system including a main body, a cultivating dish, an environmental condition detecting unit, a control center module, and an actuation unit. The main body has an accommodating space. The cultivating dish is located in the accommodating space for cultivating a plant. The environmental condition detecting unit is located in the accommodating space for detecting an environment parameter in the accommodating space and correspondingly generating an environment parameter signal. The control center module includes a wireless transceiver module and a system chipset module. The wireless transceiver module is electrically connected to at least one monitoring device. The system chipset module is configured to transmit the environment parameter signal to the monitoring device through the wireless transceiver module, and to receive a controlling actuation signal from the monitoring device through the wireless transceiver module. The actuation unit is located in the main body and configured to actuate according to the controlling actuation signal to adjust the environment parameter.

In an embodiment of the present disclosure, the system chipset module is configured to generate a logical actuation signal according to the environment parameter. The actuation unit is configured to actuate according to the logical actuation signal to adjust the environment parameter.

In an embodiment of the present disclosure, the system chipset module embeds a logical program. The system chipset module is configured to generate the logical actuation signal according to the logical program and the environment parameter. The system chipset module is configured to modify the logical program according to a customized logical signal transmitted by the monitoring device.

In an embodiment of the present disclosure, the system chipset module generates the logical actuation signal according to a time parameter set by the logical program.

In an embodiment of the present disclosure, the system chipset module is a system-on-chip (SOC).

In an embodiment of the present disclosure, the environment parameter is a temperature of the cultivating dish. The environmental condition detecting unit is configured to detect the temperature, and the actuation unit is configured to adjust the temperature.

In an embodiment of the present disclosure, the plant cultivation system includes a cultivation fluid tank and a fluid supply device. The cultivation fluid tank stores a fluid. The fluid supply device is configured to supply the fluid to the cultivating dish. The actuation unit is located in the cultivation fluid tank. The actuation unit includes a cooling device and a heating device. The cooling device is configured to reduce the temperature of the cultivation fluid tank. The heating device is configured to raise the temperature of the cultivation fluid tank.

In an embodiment of the present disclosure, the environment parameter is a humidity of the cultivating dish. The environmental condition detecting unit is configured to detect the humidity, and the actuation unit is configured to transport a fluid to the cultivating dish to adjust the humidity.

In an embodiment of the present disclosure, the environment parameter is a brightness of the cultivating dish. The environmental condition detecting unit is configured to detect the brightness, and the actuation nit is configured to adjust the brightness.

In an embodiment of the present disclosure, the environment parameter is a concentration of carbon dioxide of the cultivating dish. The environmental condition detecting unit is configured to detect the concentration of carbon dioxide (CO₂), and the actuation unit is configured to supply carbon dioxide to the cultivating dish to adjust the concentration of carbon dioxide.

In an embodiment of the present disclosure, the plant cultivation system includes a physical control device located in the main body. The physical control device includes a plurality of buttons configured to allow manipulation of the actuation unit.

In an embodiment of the present disclosure, the plant cultivation system includes a physical control device located in the main body. The physical control device includes a touch display device configured to allow manipulation of the actuation unit.

In an embodiment of the present disclosure, the wireless transceiver module utilizes Bluetooth®, Wi-Fi®, or ZigBee® technology.

In an embodiment of the present disclosure, the plant cultivation system includes a network camera. The network camera is configured to capture an image of the cultivating dish to generate a picture signal. The system chipset module is configured to transmit the picture signal to the monitoring device through the wireless transceiver module.

In an embodiment of the present disclosure, the plant cultivation system includes a gateway. The number of the at least one monitoring device is plural, and the monitoring devices are electrically connected to the wireless transceiver module wirelessly through the gateway.

The present disclosure further provides another plant cultivation system including a main body, a plurality of cultivating dishes, a plurality of environmental condition detecting units, a control center module, and a plurality of actuation units. The main body has a plurality of accommodating spaces. The cultivating dishes are configured to cultivate at least one kind of plant. Each of the cultivating dishes is located in one of the accommodating spaces. Each of the environmental condition detecting units is located in one of the accommodating spaces for detecting an environment parameter of the corresponding accommodating space and correspondingly generating an environment parameter signal. The control center module includes a wireless transceiver module and a system chipset module. The wireless transceiver module is electrically connected to at least one monitoring device wirelessly. The system chipset module is configured to transmit the environment parameter signal to the monitoring device through the wireless transceiver module, and to receive a plurality of the controlling actuation signals from the monitoring device through the wireless transceiver module. The actuation units are located in the main body. Each of the actuation units is configured to actuate according to one of the controlling actuation signals to adjust the environment parameter of the corresponding cultivating dish.

In an embodiment of the present disclosure, the system chipset module is configured to generate a logical actuation signal according to each of the environment parameters. Each of the actuation units is configured to actuate according to one of the logical actuation signals to adjust the corresponding environment parameter.

In an embodiment of the present disclosure, the system chipset module embeds a logical program. The system chipset module is configured to generate each of the logical actuation signals according to the logical program and the corresponding environment parameter. The system chipset is configured to modify the logical program according to a customized logical signal transmitted by the monitoring device.

Accordingly, when a horticulturist goes out, the horticulturist can take care of a plant and modify the settings according to the growing requirements of the plant. Moreover, when the horticulturist goes out, the plant cultivation system detects an environment parameter (i.e., the temperature, humidity, concentration of carbon dioxide, or brightness of the cultivating dish), and informs the horticulturist of the environment parameter in the plant cultivation system to allow him or her to adjust the environment parameter through the monitoring device. Consequently, the horticulturist can adjust the growing conditions according to the actual needs of the plant. The plant cultivation system can modify the logical program through the monitoring device to offer a better growing environment, such that the plant can be real time and appropriately cared.

### BRIEF DESCRIPTION OF THE DRAWINGS

FIG. 1 is a top perspective view of a plant cultivation system according to an embodiment of the present disclosure.

FIG. 2 is a bottom perspective view of the plant cultivation system in FIG. 1.

FIG. 3 is a front schematic view of the plant cultivation system in FIG. 2.

FIG. 4 is a block diagram of he plant cultivation system according to an embodiment of the present disclosure.

FIG. 5 is a block diagram of the plant cultivation system according to another embodiment of the present disclosure.

FIG. 6 is a block diagram of the plant cultivation system according to another embodiment of the present disclosure.

### DETAILED DESCRIPTION

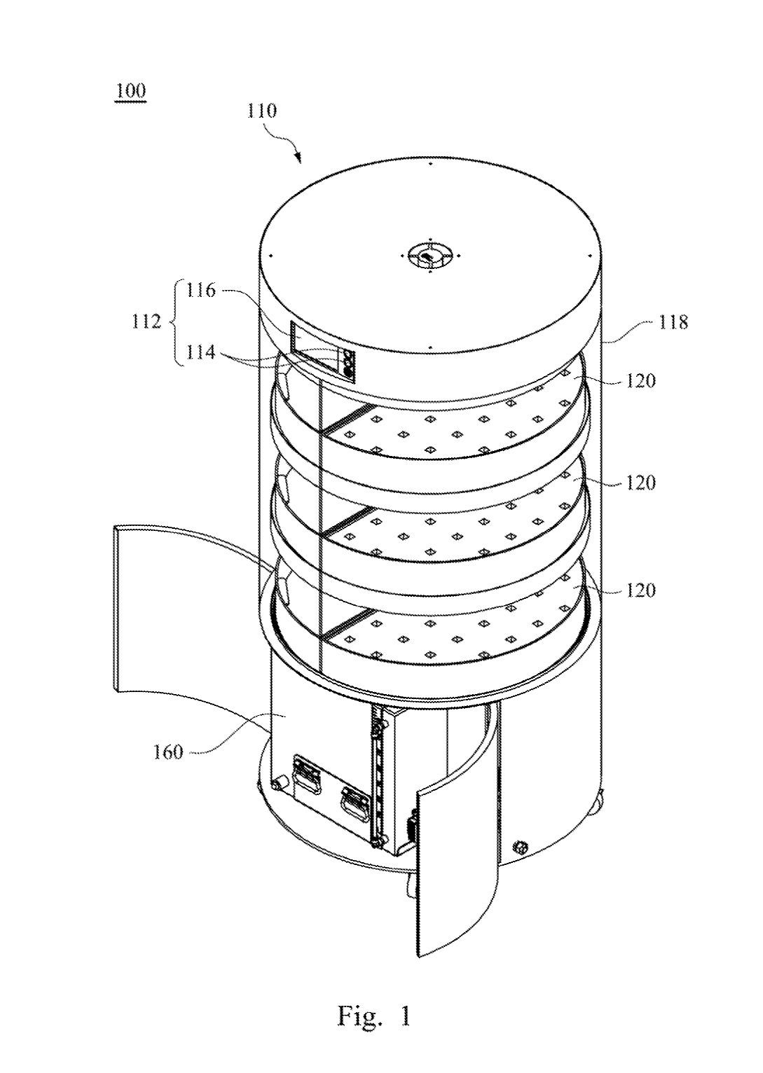

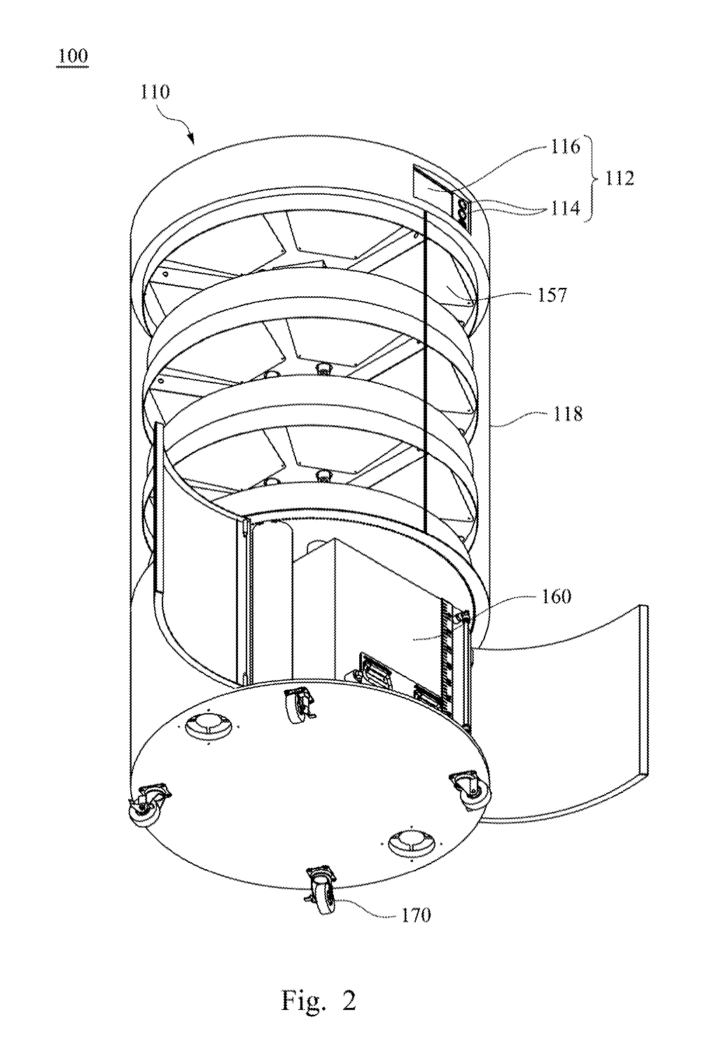

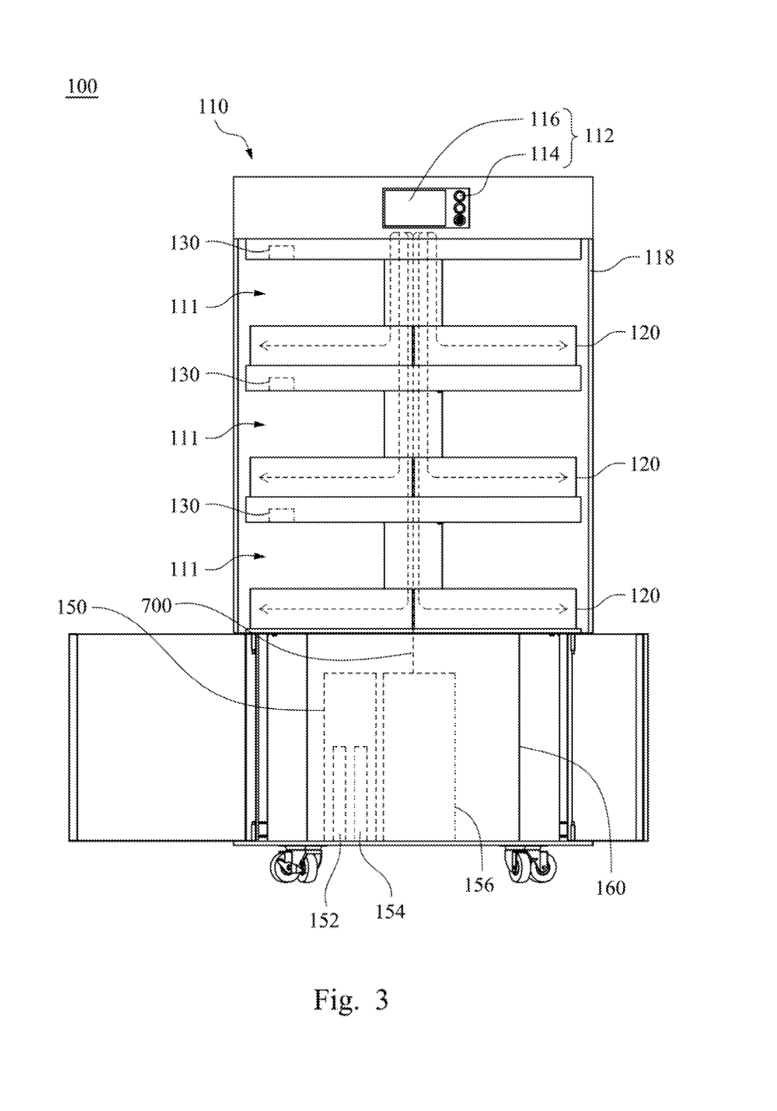

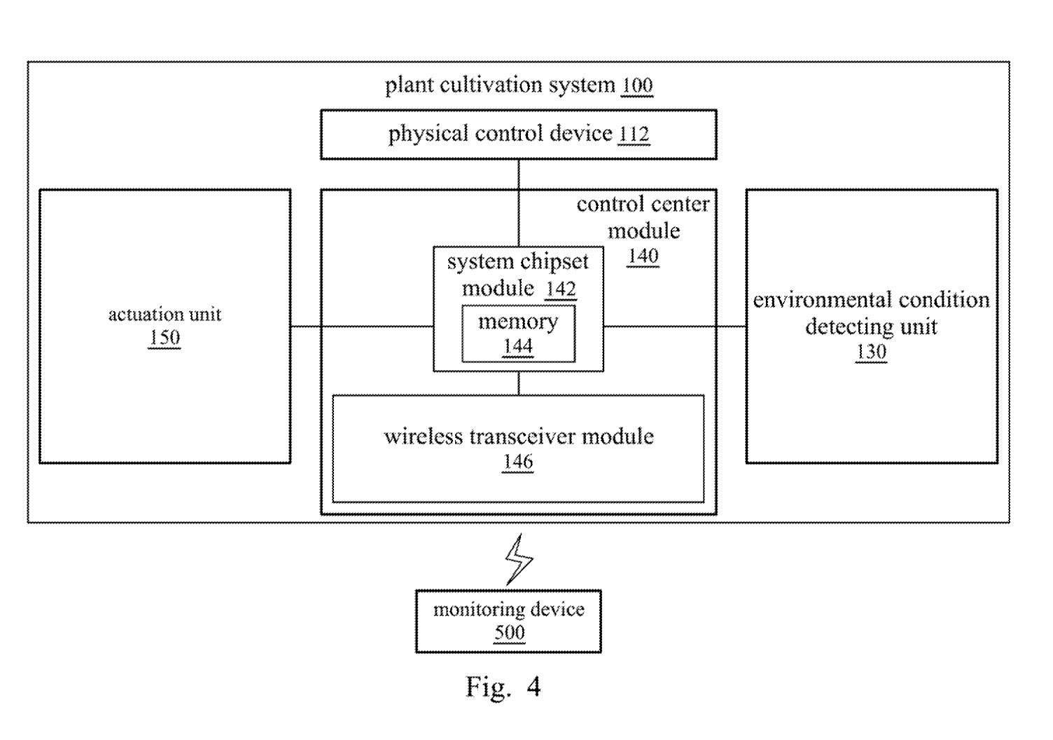

FIG. 1 is a top perspective view of a plant cultivation system 100 according to a first embodiment of the present disclosure. FIG. 2 is a bottom perspective view of the plant cultivation system 100 in FIG. 1. FIG. 3 is a front schematic view of the plant cultivation system 100 in FIG. 2. FIG. 4 is a block diagram of the plant cultivation system 100 according to an embodiment of the present disclosure.

As shown in FIG. 1 to FIG. 4, the plant cultivation system 100 includes a main body 110, a cultivating dish 120, an environmental condition detecting unit 130, a control center module 140, and an actuation unit 150. The main body 110 has an accommodating space 111 which is defined by a transparent cover 118 and used for cultivating a plant. The cultivating dish 120 is located in the accommodating space 111. The environmental condition detecting unit 130 is located in the accommodating space 111 for detecting an environment parameter n the accommodating space 111 and correspondingly generating an environment parameter signal.

The control center module 140 includes a wireless transceiver module 146 and a system chipset module 142. The wireless transceiver module 146 is electrically connected to at least one monitoring device 500 wirelessly. The system chipset module 142 is configured to transmit the environment parameter signal to the monitoring device 500 through the wireless transceiver module 146, and to receive a controlling actuation signal from the monitoring device 500 through the wireless transceiver module 146. The actuation unit 150 is located in the main body 110 and configured to actuate according to the controlling actuation signal to adjust the environment parameter.

Accordingly, when a horticulturist goes out, the horticulturist can take care of the plant by the monitoring device 500, as described below. The environmental condition detecting unit 130 in the plant cultivation system 100 can detect the environment parameter (e.g., the temperature, humidity, or brightness) and generate the environment parameter signal to transmit to the system chipset module 142 of the control center module 140. The system chipset module 142 transmits the environment parameter signal to the monitoring device 500 (e.g., cellphone, tablet, or computer) of the horticulturist to inform the horticulturist of the environment parameter of the plant cultivation system 100 and to let the horticulturist adjust the environment parameter. Subsequently, the horticulturist transmits the controlling actuation signal (e.g., corresponding to increasing brightness) through the monitoring device 500. The wireless transceiver module 146 in the plant cultivation system 100 is configured to receive the controlling actuation signal and transmit the controlling actuation signal to the system chipset module 142. The system chipset module 142 then transmits the controlling actuation signal to the actuation unit 150. The actuation unit 150 adjusts the environment parameter according to the controlling actuation signal. Consequently, the horticulturist can adjust the growing condition according to the actual needs of the plant.

In this embodiment, the system chipset module 142 is configured to generate a logical actuation signal according to the environment parameter. The actuation unit 150 is configured to actuate according to the logical actuation signal to adjust the environment parameter.

That is, in addition to the horticulturist being able to remotely control the plant cultivation system 100, the plant cultivation system 100 can also adjust the plant growing condition automatically according to the environment parameter. The environmental condition detecting unit 130 transmits the environment parameter to the system chipset module 142, and the system chipset module 142 can generate the logical actuation signal according to the environment parameter and transmit the logical actuation signal to the actuation unit 150 automatically. The actuation unit 150 acts according to the logical actuation signal, for example, to increase the temperature and thereby adjust the environment to satisfy the growing requirements of the plant.

Furthermore, in this embodiment, the system chipset module 142 embeds a logical program. The system chipset module 142 is configured to generate the logical actuation signal according to the logical program and the environment parameter. The system chipset module 142 is configured to modify the logical program according to a customized logical signal transmitted by the monitoring device 500.

To be specific, the system chipset module 142 includes a memory 144, for storing the logical program. When the system chipset module 142 receives the environment parameter, the system chipset module 142 generates the logical actuation signal according to the setting of the logical program. For example, if the logical program sets the temperature at 30 degrees, and the environmental condition detecting unit 130 detects that the temperature of the cultivating dish 120 is higher than 30 degrees and transmits a corresponding signal of the temperature to the system chipset module 142, the system chipset module 142 uses the logical program to determine that the temperature is too high and transmits a corresponding logical actuation signal to make the actuation unit 150 reduce the temperature to 30 degrees. The horticulturist can transmit the customized logical signal through the web page or mobile application software (APP) of the monitoring device 500 in order to modify the logical program. For example, the temperature may be set to 28 degrees from 30 degrees to satisfy the growing requirement of the plant.

In some embodiments, the system chipset module 142 generates the logical actuation signal according to a time parameter set by the logical program. Because the logical program contains the time parameter, the system chipset module 142 can trigger the actuation unit 150 without the monitoring device 500 or the environmental condition detecting unit 130. At a set time, the logical program transmits the controlling actuation signal to the actuation unit 150 to act. For example, the logical program can transmit the controlling actuation signal to a fluid supply device 156 (see FIG. 3) everyday to supply water at the set time.

In this embodiment, the system chipset module 142 is a system-on-chip (SOC). The system-on-chip is fully encapsulated and can endure the high temperatures and the high humidity of the plant cultivation system 100, such that the plant cultivation system 100 is more stable and its life span is increased.

In this embodiment, the wireless transceiver module 146 can utilize Bluetooth®, Wi-Fi®, or ZigBee® technology. The horticulturist can selectively connect using one of these technologies according to actual needs. Utilizing Bluetooth® technology allows for high-speed transmission over a short distance. Utilizing Wi-Fi® technology allows for the horticulturist remotely control the plant cultivation system 100 through a network. Utilizing ZigBee® technology allows for large-bandwidth transmission over a short distance. When the transparent cover 118 of the plant cultivation system 100 is confined, the temperature and humidity of the accommodating space 111 can be maintained.

In this embodiment, the environment parameter is a temperature of the cultivating dish 120. The environmental condition detecting unit 130 is configured to detect the temperature, and the actuation unit 150 is configured to adjust the temperature to maintain an appropriate temperature for the plant to grow.

In some embodiments, the environment parameter can be a brightness of the cultivating dish 120. In this case, the environmental condition detecting unit 130 can be configured to detect the brightness, and the actuation unit 150 can be configured to adjust the brightness. Because the horticulturist may place the plant cultivation system 100 on a balcony and the brightness is not fixed, the ability to automatically adjust the brightness may be required.

In some embodiments, the environment parameter can be a concentration of carbon dioxide (CO₂) of the cultivating dish 120. In this case, the environmental condition detecting unit 130 can be configured to detect the concentration of carbon dioxide, and the actuation unit 150 can be configured to supply carbon dioxide to the cultivating dish 120 to adjust the concentration of carbon dioxide. Carbon dioxide is a kind of nutrient for plants.

With reference to FIG. 3 and FIG. 4, in this embodiment, the environmental condition detecting unit 130 is configured to detect the temperature. The plant cultivation system 100 includes a cultivation fluid tank 160 and a fluid supply device 156. The cultivation fluid tank 160 stores a fluid 700. The fluid supply device 156 is configured to supply the fluid 700 to the cultivating dish 120. The actuation unit 150 is located in the cultivation fluid tank 160. The actuation unit 150 includes a cooling device 152 and a heating device 154. The cooling device 152 is configured to reduce the temperature of the cultivation fluid tank 160. The heating device 154 is configured to raise the temperature of the cultivation fluid tank 160. The roots of the plant are sensitive to temperature. Therefore, adjusting the temperature of the fluid 700 and transporting the fluid 700 to the cultivating dish 120 is a more efficient way to adjust the temperature. Furthermore, power can be saved by adjusting the temperature of the fluid 700 rather than adjusting the temperature of air.

Moreover, in some embodiments, the environment parameter can be a humidity of the cultivating dish 120. In this case, the environmental condition detecting unit 130 can be configured to detect the humidity, and the actuation unit 150 can be configured to transport a fluid 700 to the cultivating dish 120 to adjust the humidity.

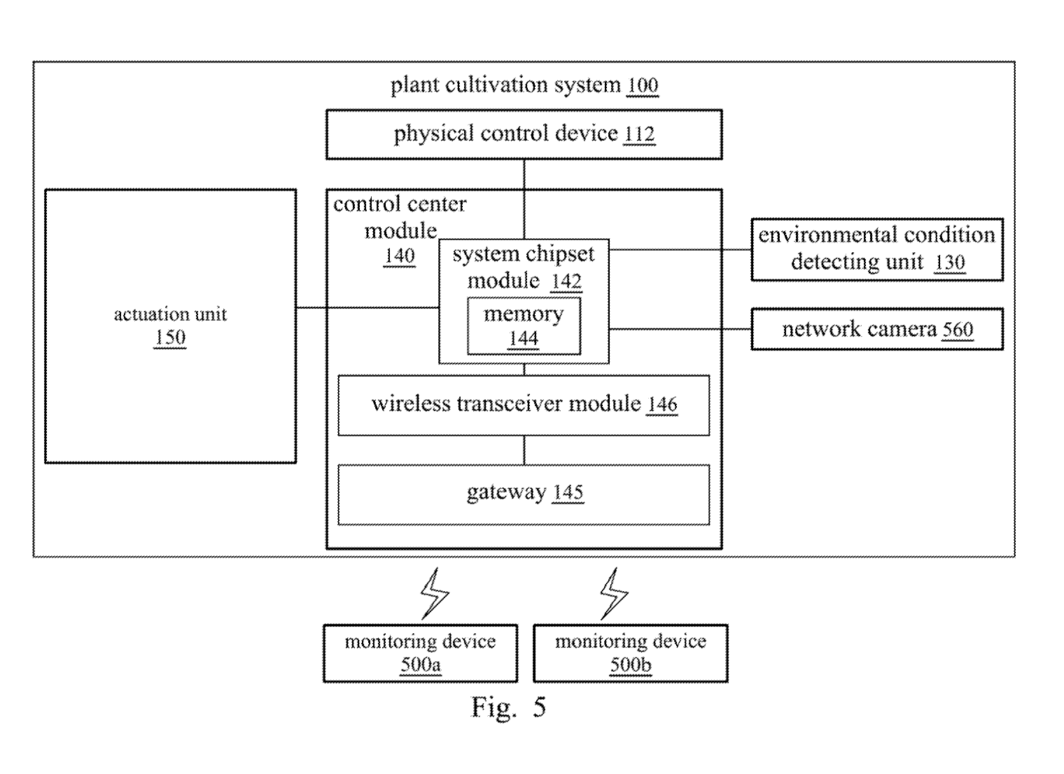

FIG. 5 is a block diagram of the plant cultivation system 100 according to a second embodiment of the present disclosure. The difference between the second embodiment of the present disclosure and the first embodiment of the present disclosure is that the plant cultivation system 100 includes a network camera 560, and there are a plurality of the monitoring devices 500a, 500b. The network camera 560 is configured to capture an image of the cultivating dish 120 to generate a picture signal. The system chipset module 142 is configured to transmit the picture signal to the monitoring devices 500a, 500b through the wireless transceiver module 146. Therefore, the horticulturist can see the plant in real time.

Another difference between the second embodiment of the present disclosure and the first embodiment of the present disclosure is that in this embodiment, the plant cultivation system 100 further includes a gateway 145. The gateway 145 is configured to be connected to the monitoring devices 500a, 500b. The monitoring device 500a and the monitoring device 500b are electrically connected to the wireless transceiver module 146 wirelessly through the gateway 145. There are a variety of different kinds of electrical devices available today. In order to satisfy the needs of the horticulturist, the gateway 145 of the plant cultivation system 100 can be connected to different electrical devices (e.g., cellphone, tablets, or computers). The gateway 145 can transmit signals of different devices to the system chipset module 142 in order. People having ordinary skill in the art can make proper modifications with respect to the quantity of the monitoring devices according to their actual needs.

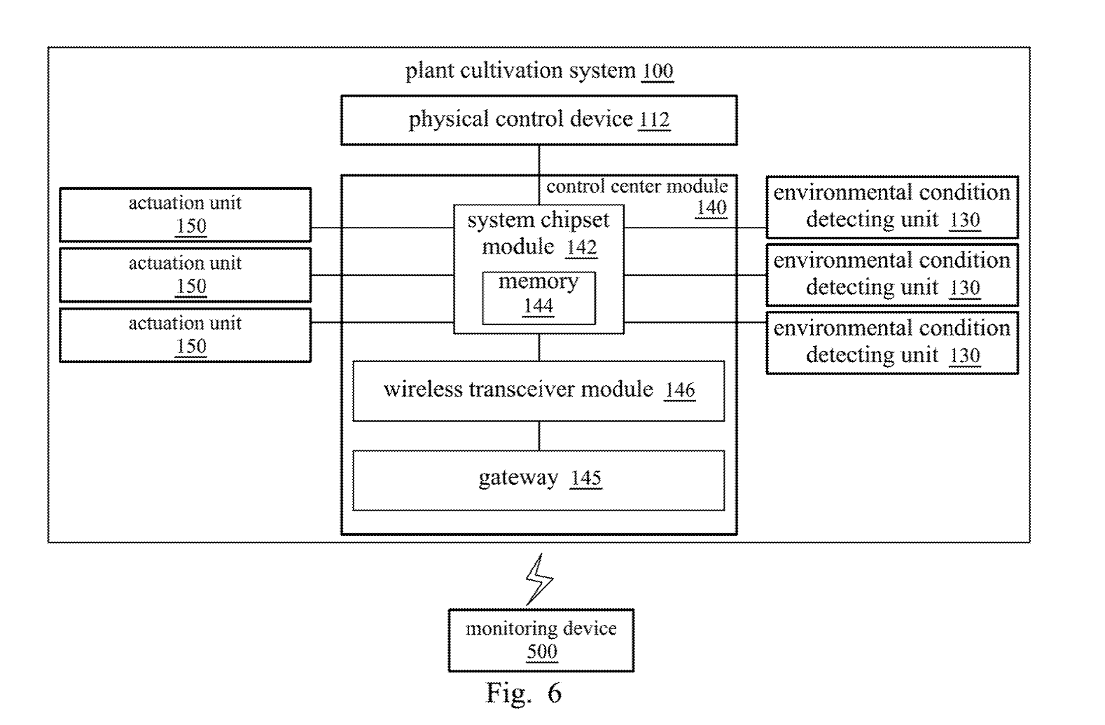

FIG. 6 is a block diagram of the plant cultivation system 100 according to a third embodiment of the present disclosure. As shown in FIG. 1 to FIG. 3, and FIG. 6, the difference between the third embodiment of the present disclosure and the first embodiment of the present disclosure is that the plant cultivation system 100 comprises a plurality of cultivating dishes 120, a plurality of the environmental condition detecting units 130, and a plurality of actuation units 150 for the horticulturist to plant different kind of plants. The system chipset module 142 can encode each of the environmental condition detecting units 130 and each of the actuation units 150. Therefore, the plant cultivation system 100 can transmit the environment parameters from different cultivating dishes 120 to the corresponding actuation unit 150. The horticulturist can transmit different controlling actuation signals to the corresponding actuation unit 150 according to the different needs of the plants in the different cultivating dishes 120.

Another difference between the third embodiment of the present disclosure and the first embodiment of the present disclosure is that in this embodiment, the plant cultivation system 100 includes a physical control device 112 located in the main body 110. The physical control device 112 includes a plurality of buttons 114 configured to operate the actuation units 150. In some embodiments, the physical control device 112 includes a touch display device 116 configured to operate the actuation unit 150.

Another difference between the third embodiment of the present disclosure and the first embodiment of the present disclosure is that in this embodiment, the physical control device 112 is electrically connected to the system chipset module 142 to operate the actuation units 150. The button 114 can be manipulated to perform start, stop, and reset functions. In this embodiment, the touch display device 116 can replace the monitoring device 500. Moreover, in this embodiment, the plant cultivation system 100 includes wheels 170, such that the horticulturist can move the plant cultivation system 100 to a suitable place as needed.

Accordingly, when a horticulturist goes out, the horticulturist can take care of a plant and modify the settings according to the growing requirements of the plant. Moreover, when the horticulturist goes out, the plant cultivation system detects an environment parameter (i.e., the temperature, humidity, concentration of carbon dioxide, or brightness of the cultivating dish), and informs the horticulturist of the environment parameter in the plant cultivation system to allow him or her to adjust the environment parameter through the monitoring device. Consequently, the horticulturist can adjust the growing conditions according to the actual needs of the plant. The plant cultivation system can modify the logical program through the monitoring device to offer a better growing environment, such that the plant can be real time and appropriately cared.

What is claimed is

1. A plant cultivation system, comprising:
a main body having an accommodating space;
a cultivating dish located in the accommodating space for cultivating a plant;
an environmental condition detecting unit located in the accommodating space for detecting an environment parameter in the accommodating space and correspondingly generating an environment parameter signal;
a control center module, comprising:
a wireless transceiver module electrically connected to at least one monitoring device; and
a system chipset module configured to transmit the environment parameter signal to the monitoring device through the wireless transceiver module, and to receive a controlling actuation signal from the monitoring device through the wireless transceiver module; and
an actuation unit located in the main body and configured to actuate according to the controlling actuation signal to adjust the environment parameter.

2. The plant cultivation system of claim 1, wherein the system chipset module is configured to generate a logical actuation signal according to the environment parameter, and the actuation unit is configured to actuate according to the logical actuation signal to adjust the environment parameter.

3. The plant cultivation system of claim 2, wherein the system chipset module embeds a logical program, the system chipset module is configured to generate the logical actuation signal according to the logical program and the environment parameter, and the system chipset module is configured to modify the logical program according to a customized logical signal transmitted by the monitoring device.

4. The plant cultivation system of claim 3, wherein the system chipset module generates the logical actuation signal according to a time parameter set by the logical program.

5. The plant cultivation system of claim 1, wherein the system chipset module is a system-on-chip (SOC).

6. The plant cultivation system of claim 1, wherein the environment parameter is a temperature of the cultivating dish, the environmental condition detecting unit is configured to detect the temperature, and the actuation unit is configured to adjust the temperature.

7. The plant cultivation system of claim 6, further comprising a cultivation fluid tank and a fluid supply device, wherein the cultivation fluid tank stores a fluid, the fluid supply device is configured to supply the fluid to the cultivating dish, the actuation unit is located in the cultivation fluid tank, the actuation unit comprises a cooling device and a heating device, the cooling device is configured to reduce the temperature of the cultivation fluid tank, and the heating device is configured to raise the temperature of the cultivation fluid tank.

8. The plant cultivation system of claim 1, wherein the environment parameter is a humidity of the cultivating dish, the environmental condition detecting unit is configured to detect the humidity, and the actuation unit is configured to transport a fluid to the cultivating dish to adjust the humidity.

9. The plant cultivation system of claim 1, wherein the environment parameter is a brightness of the cultivating dish, the environmental condition detecting unit is configured to detect the brightness, and the actuation unit is configured to adjust the brightness.

10. The plant cultivation system of claim 1, wherein the environment parameter is a concentration of carbon dioxide (CO₂) of the cultivating dish, the environmental condition detecting unit is configured to detect the concentration of carbon dioxide, and the actuation unit is configured to supply carbon dioxide to the cultivating dish to adjust the concentration of carbon dioxide.

11. The plant cultivation system of claim 1, further comprising a physical control device located in the main body, wherein the physical control device comprises a plurality of buttons configured to operate the actuation unit.

12. The plant cultivation system of claim 1, further comprising a physical control device located in the main body, wherein the physical control device comprises a touch display device configured to allow manipulation of the actuation unit.

13. The plant cultivation system of claim 1, wherein the wireless transceiver module utilizes Bluetooth®, Wi-Fi®, or ZigBee® technology.

14. The plant cultivation system of claim 1, further comprising a network camera, wherein the network camera is configured to capture an image of the cultivating dish to generate a picture signal, and the system chipset module is configured to transmit the picture signal to the monitoring device through the wireless transceiver module.

15. The plant cultivation system of claim 1, further comprising a gateway, and the monitoring devices are electrically connected to the wireless transceiver module wirelessly through the gateway.

16. A plant cultivation system, comprising:
a main body having a plurality of accommodating spaces;
a plurality of cultivating dishes configured to cultivate at least one kind of plant, each of the cultivating dishes being located in one of the accommodating spaces;
a plurality of environmental condition detecting units, each of the environmental condition detecting units being located in one of the accommodating spaces for detecting an environment parameter of the corresponding accommodating space and correspondingly generating an environment parameter signal;
a control center module, comprising:
a wireless transceiver module electrically connected to at least one monitoring device; and
a system chipset module configured to transmit the environment parameter signal to the monitoring device through the wireless transceiver module, and to receive a plurality of the controlling actuation signals from the monitoring device through the wireless transceiver module; and
a plurality of actuation units located in the main body, each of the actuation units being configured to actuate according to one of the controlling actuation signals to adjust the environment parameter of the corresponding cultivating dish.

17. The plant cultivation system of claim 16, wherein the system chipset module is configured to generate a logical actuation signal according to each of the environment parameters, and each of the actuation units is configured to actuate according to one of the corresponding logical actuation signals to adjust the corresponding environment parameter.

18. The plant cultivation system of claim 17, wherein the system chipset module embeds a logical program, the system chipset module is configured to generate each of the logical actuation signals according to the logical program and the corresponding environment parameter, and the system chipset is configured to modify the logical program according to a customized logical signal transmitted by the monitoring device.

19. The plant cultivation system of claim 18, wherein the system chipset module generates the logical actuation signal according to a time parameter set by the logical program.

20. The plant cultivation system of claim 16, wherein the system chipset module is a system-on-chip (SOC).
